(19) United States
(12) Patent Application Publication
(10) Pub. No.: US 2026/0322044 A1
(43) Pub. Date: Oct. 15, 2026

(54) PLUG TYPE RESIDUAL CURRENT OPERATED PROTECTOR

(71) Applicant: Jiangsu Barep Smart Technology Co.,Ltd, Zhangjiagang (CN)

(72) Inventors: Jiangang Chen, Zhangjiagang (CN); Xiaobo Zheng, Zhangjiagang (CN)

(21) Appl. No.: 19/464,833

(22) Filed: Jan. 30, 2026

(30) Foreign Application Priority Data
Jun. 12, 2025 (CN) 202510780673.1

(51) Int. Cl. H01R 13/713; H01H 71/24; H01H 71/58; H01R 13/633; H01R 24/28; H01R 103/00

(52) U.S. Cl. CPC H01R 13/713; H01H 71/2481; H01H 71/58; H01R 13/633; H01R 24/28; H01R 2103/00

(57) ABSTRACT

The present disclosure discloses a plug type residual current operated protector, including: a plug housing; a trip module, including a yoke, an armature, a lifter, and a hook block, where one end of the armature is elastically connected to the plug housing through a first spring, the lifter is in sliding connection with an interior of the plug housing, an extension arm is arranged on a side surface of the lifter, the extension arm extends below the elastic piece, the hook block is rotatably mounted in the lifter, and a first hooking part is arranged at a top of the hook block.

### TECHNICAL FIELD

The present disclosure relates to the technical field of residual current devices, and in particular, to a plug type residual current operated protector.

### BACKGROUND

A household electrical appliance is connected to a mains power supply through a power plug. A leakage protection structure is arranged inside the power plug, to provide instant protection for electrical equipment and personal safety. The leakage protection structure inside the power plug cuts off power within 0.03-0.1 second when residual current exceeds a set threshold (usually less than or equal to 30 mA).

In an existing leakage protection structure inside the power plug, a trip device for connecting or disconnecting a moving contact to or from a static contact has a complex structure and poor reliability, resulting in a potential safety hazard in the power plug.

### SUMMARY

An objective of the present disclosure is to provide a plug type residual current operated protector, to solve problems that an existing trip device for leakage protection inside a power plug has a complex structure and poor reliability.

To achieve the above objective, the present disclosure adopts the following technical solution:
a plug type residual current operated protector includes: a plug housing, where a circuit board is arranged inside the plug housing, a static electrical contact is arranged on the circuit board, one end of an elastic piece is fixedly mounted in the plug housing, and a free end of the elastic piece is provided with a moving electrical contact corresponding to a position of the static electrical contact;
a trip module, including a yoke, an armature, a lifter, and a hook block, where the yoke is arranged in a trip coil, the armature corresponds to a position of the yoke, one end of the armature is elastically connected to the plug housing through a first spring, the armature penetrates through the lifter, the hook block, and the trip coil, the lifter is in sliding connection to an interior of the plug housing, an extension arm is arranged on a side surface of the lifter, the extension arm extends below the elastic piece, the hook block is rotatably mounted in the lifter, an annular flange is arranged on the armature, the annular flange is in contact with a surface of the hook block, and a first hooking part is arranged at a top of the hook block; and
a reset button, which is elastically connected to the plug housing through a second spring, where one end of the second spring is in contact with a back surface of a pressing part of the reset button, an opposite end is in contact with the circuit board, a second hooking part configured to hook the first hooking part is provided at a bottom of the reset button, and contact surfaces of the second hooking part and the first hooking part are inclined surfaces.

As a further description of the above technical solution:
a chute with a shape matching the annular flange is provided on the hook block, and the annular flange is in sliding connection with an interior of the chute.

As a further description of the above technical solution:
contact surfaces of the extension arm and the elastic piece are cambered surfaces.

As a further description of the above technical solution:
a stop block corresponding to a position of the first hooking part is arranged inside the lifter.

As a further description of the above technical solution:
a surface of the plug housing is provided with a concave part, and the reset button is arranged on a bottom surface of the concave part.

As a further description of the above technical solution:
anti-slip groove bodies are provided on opposite side surfaces of the plug housing.

In conclusion, due to the adoption of the above technical solution, the present disclosure has the beneficial effects that:
1. In the present disclosure, because the contact surfaces when the second hooking part at the bottom of the reset button is hooked with the first hooking part on the hook block are inclined surfaces, the reset button and the hook block cannot be hooked tightly. When a leakage fault occurs, the armature and the yoke do not have electromagnetic attraction, so that the hook block is not positioned by the armature again, and the hook block is rotatable. Therefore, the reset button moves up and down under an action of elastic force of the second spring, so that the reset button is disengaged from the hook block, and then the lifter moves downward under an action of self-gravity of the lifter and elastic force applied to the extension arm by the elastic piece, and the moving electrical contact at an end part of the elastic piece is separated from the static electrical contact to quickly cut off a circuit. The hook block does not need to be provided with a torsional spring at a rotating shaft as that in a conventional art to achieve tripping from the reset button, thereby effectively simplifying a structure of a trip module of the plug type residual current operated protector, and improving reliability of leakage protection.
2. In the present disclosure, a stop block corresponding to a position of the first hooking part is arranged inside the lifter. When the hook block rotates in a vertical state, since a width of the first hooking part is greater than a width of the second hooking part, a part that is of a side end part of the first hooking part and that exceeds the second hooking part is pressed against by the stop block, thereby limiting a rotation angle of the hook block.

### BRIEF DESCRIPTION OF THE DRAWINGS

In order to describe the technical solution of the embodiments of the present disclosure more clearly, accompanying drawings required to be used in the embodiments will be briefly introduced. It should be understood that the following accompanying drawings only show some embodiments of the present disclosure, so they should not be regarded as the limitation of the scope. For those of ordinary skill in the art, other related drawings may also be obtained according to these drawings without creative effort.

FIG. 1 is a schematic structural diagram of a plug type residual current operated protector.

FIG. 2 is a partial sectional view of a plug type residual current operated protector.

FIG. 3 is a partial enlarged view of part A in FIG. 2.

FIG. 4 is a first schematic diagram of tripping of a trip module in a plug type residual current operated protector.

FIG. 5 is a second schematic diagram of tripping of a trip module in a plug type residual current operated protector.

FIG. 6 is a first schematic diagram of a power supply state of a trip module in a plug type residual current operated protector.

FIG. 7 is a second schematic diagram of a power supply state of a trip module in a plug type residual current operated protector.

FIG. 8 is a schematic diagram of pressing of a reset button of a trip module in a plug type residual current operated protector.

### REFERENCE SIGNS IN THE DRAWINGS

1, plug housing; 11, circuit board; 12, static electrical contact; 13, elastic piece; 131, moving electrical contact; 14, concave part; 15, anti-slip groove body; 2, trip module; 21, yoke; 211, trip coil; 22, armature; 221, first spring; 222, annular flange; 23, lifter; 231, extension arm; 232, stop block; 24, hook block; 241, chute; 3, reset button; and 31, second spring.

### DETAILED DESCRIPTION OF THE EMBODIMENTS

Technical solutions in embodiments of the present disclosure will be clearly and completely described below with reference to accompanying drawings in the embodiments of the present disclosure. Apparently, the described embodiments are merely part rather than all of the embodiments of the present disclosure. All other embodiments obtained by those of ordinary skill in the art based on the embodiments of present disclosure without creative efforts fall within the scope of protection of the present disclosure.

### Embodiment 1

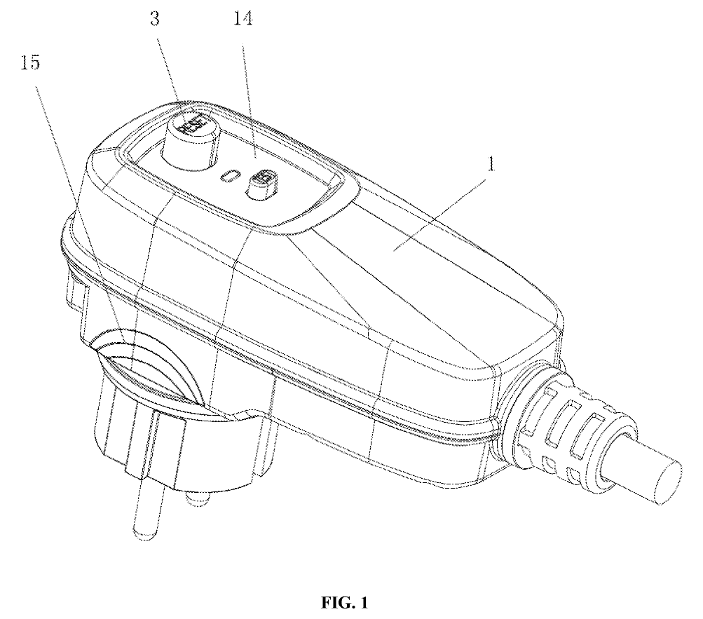

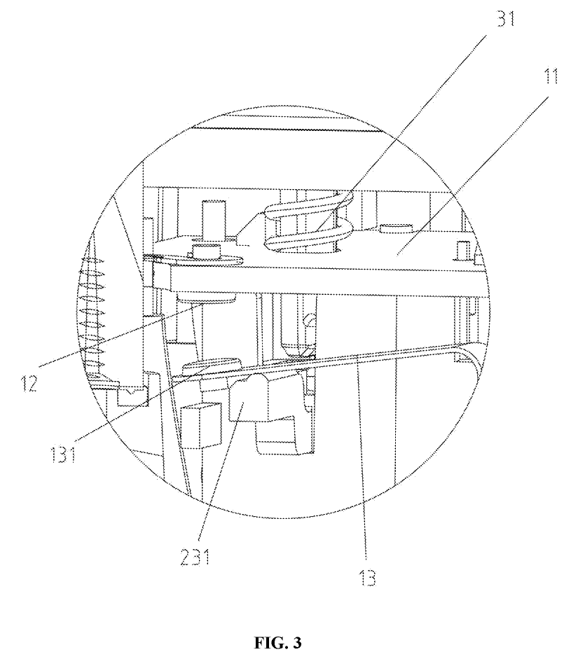

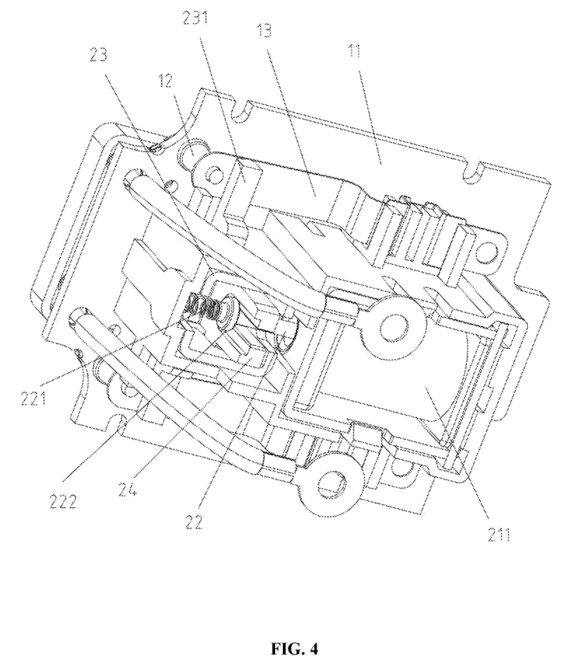

Referring to FIGS. 1-8, the present disclosure provides a technical solution: a plug type residual current operated protector includes:
a plug housing 1, where a circuit board 11 is arranged inside the plug housing 1, a static electrical contact 12 is arranged on the circuit board 11, one end of an elastic piece 13 is fixedly mounted in the plug housing 1, and a free end of the elastic piece 13 is provided with a moving electrical contact 131 corresponding to a position of the static electrical contact 12;
a trip module 2, including a yoke 21, an armature 22, a lifter 23, and a hook block 24, where the yoke 21 is arranged in a trip coil 211, the armature 22 corresponds to a position of the yoke 21, one end of the armature 22 is elastically connected to the plug housing 1 through a first spring 221, the armature 22 penetrates through the lifter 23, the hook block 24, and the trip coil 211, the lifter 23 is in sliding connection to an interior of the plug housing 1, an extension arm 231 is arranged on a side surface of the lifter 23, the extension arm 231 extends below the elastic piece 13, the hook block 24 is rotatably mounted in the lifter 23, an annular flange 222 is arranged on the armature 22, the annular flange 222 is in contact with a surface of the hook block 24, and a first hooking part is arranged at a top of the hook block 24; and
a reset button 3, which is elastically connected to the plug housing 1 through a second spring 31, where one end of the second spring 31 is in contact with a back surface of a pressing part of the reset button 3, an opposite end is in contact with the circuit board 11, a second hooking part configured to hook the first hooking part is provided at a bottom of the reset button 3, and contact surfaces of the second hooking part and the first hooking part are inclined surfaces.

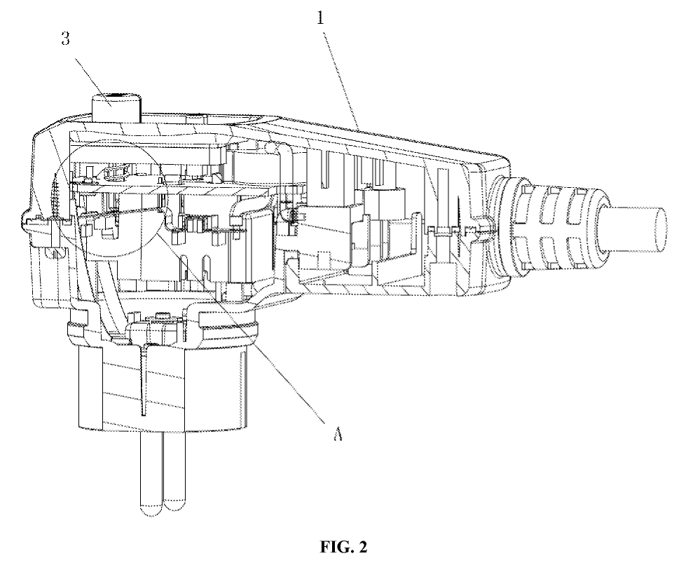

Referring to FIGS. 2-4, because the contact surfaces when the second hooking part at the bottom of the reset button 3 is hooked with the first hooking part on the hook block 24 are inclined surfaces, the reset button 3 and the hook block 24 cannot be hooked tightly. When a leakage fault occurs, the armature 22 and the yoke 21 do not have electromagnetic attraction, so that the hook block 24 is not positioned by the armature 22 any longer, and the hook block 24 is rotatable. Therefore, the reset button 3 moves upward under an action of elastic force of the second spring 31, so that the reset button 3 is disengaged from the hook block 24, and then the lifter 23 moves downward under an action of self-gravity and elastic force applied to the extension arm 231 by the elastic piece 13, and the moving electrical contact 131 at an end part of the elastic piece 13 is separated from the static electrical contact 12 to quickly cut off a circuit. The hook block 24 does not need to be provided with a torsional spring at a rotating shaft like that in a conventional art to achieve tripping from the reset button 3, thereby effectively simplifying a structure of a trip module 2 of the plug type residual current operated protector, and improving reliability of leakage protection.

Contact surfaces of the extension arm 231 and the elastic piece 13 are cambered surfaces, thereby effectively avoiding damage when the extension arm 231 presses against the elastic piece 13, and protecting the elastic piece 13.

A surface of the plug housing 1 is provided with a concave part 14, and the reset button 3 is arranged on a bottom surface of the concave part 14. A top of the preset button 3 penetrates through the bottom surface of the concave part 14, and a height of the reset button 3 extending out of a surface of the plug housing 1 is controlled to be lowered, thereby protecting the reset button 3.

Anti-slip groove bodies 15 are provided on opposite side surfaces of the plug housing 1. The anti-slip groove body 15 includes three arc-shaped groove bodies arranged concentrically, and a depth of the arc-shaped groove body is gradually reduced from bottom to top, thereby facilitating unplugging a plug, and improving use safety.

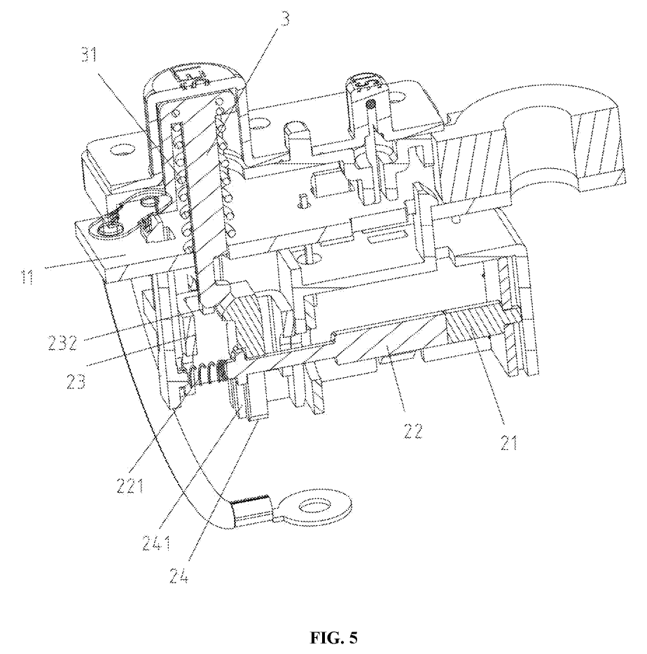

A working principle is that: an output end of a residual current device is connected to a household electrical appliance, and a state in which the reset button 3 is not operated is shown in FIG. 5.

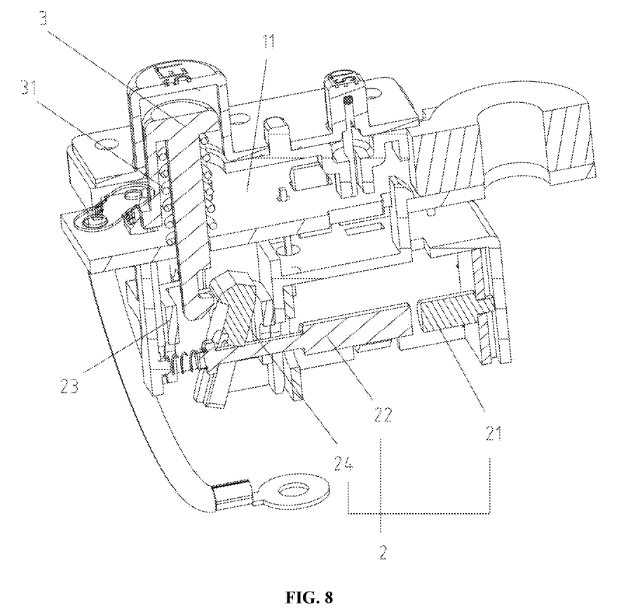

Referring to FIG. 8, when a RESET button (that is, the reset button 3) is pressed down, the reset button 3 overcomes spring force to move downward, and an inclined surface on a lower side of the second hooking part at the bottom of the reset button 3 presses against an inclined surface at an upper end of the first hooking part at a top of the hook block 24, so that the hook block 24 rotate backward, the bottom of the hook block 24 drives contact surfaces of the armature 22 and the yoke 21 to separate from each other, and the first spring 221 is compressed.

The reset button 3 continues moving downward until a pressing part of the reset button 3 moves downward to be blocked by a Printed Circuit Board (PCB) (that is, the circuit board 11), after that, the second hooking part of the reset button 3 does not press against the first hooking part any longer, the hook block 24 rotates and resets under elastic force of the first spring 221, the reset button 3 is hooked with the hook block 24, the armature 22 simultaneously moves toward the yoke 21, and the armature 22 is in contact with the yoke 21.

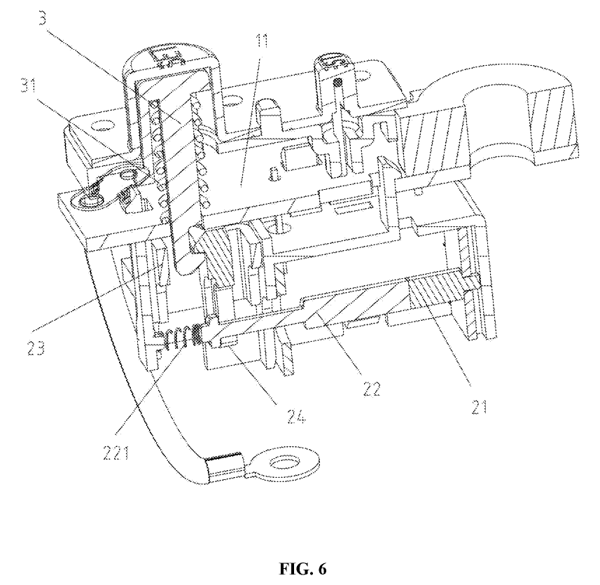

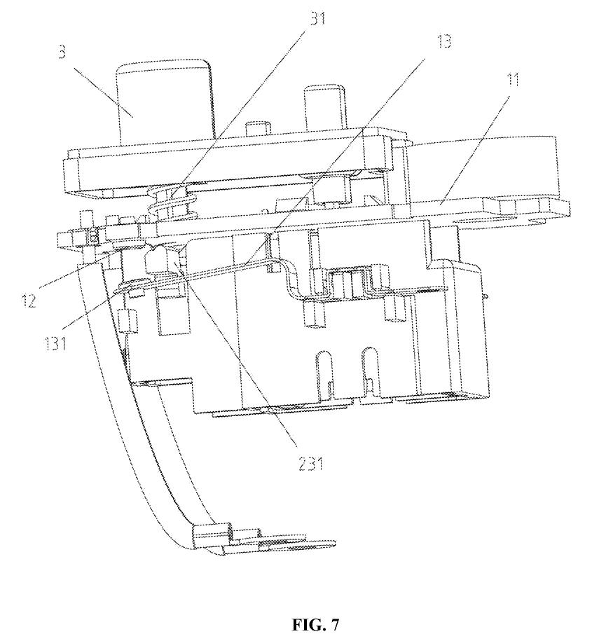

After that, the reset button 3 is released, referring to FIGS. 6-7, the reset button 3 pulls the hook block 24 to move upward, a relative position changes between the hook block 24 and the armature 22, the lifter 23 moves upward together with the hook block 24, the lifter 23 is bent upward by pressing against a free end of the elastic piece 13 through the extension arm 231, and a moving electrical contact 131 at an end part of the elastic piece 13 is in contact with a static electrical contact 12 on the PCB to achieve power on. Note: FIG. 7 does not correctly show a state of a pressed and deformed elastic piece 13, and the elastic piece 13 is actually located above the extension arm 231.

In a conventional state, the moving electrical contact 131 is in contact with the static electrical contact 12 on the PCB, which limits upward movement of the lifter 23, and the hook block 24 is pressed against the armature 22 and cannot rotate, so that the reset button 3 does not rise to a limit position, and the second spring 31 is located in a compressed state. FIG. 6 does not correctly show a position of the reset button 3 in a conventional state, and the reset button 3 does not actually reach an upward limit position.

### Embodiment 2

This embodiment further provides the following technical solution as an improvement based on the above embodiment: a chute 241 with a shape matching the annular flange 222 is provided on the hook block 24, and the annular flange 222 is in sliding connection with an interior of the chute 241.

Due to the chute 241, the annular flange 222 cannot be separated from the hook block 24 when the hook block 24 moves up and down with the lifter 23, thereby improving moving stability of the hook block 24.

### Embodiment 3

This embodiment further provides the following technical solution as an improvement based on the above embodiment: a stop block 232 corresponding to a position of the first hook part is arranged inside the lifter 23.

When the hook block 24 rotates in a vertical state, since a width of the first hooking part is greater than a width of the second hooking part, a part that is of a side end part of the first hooking part and that exceeds the second hooking part is pressed against by the stop block 232, thereby limiting a rotation angle of the hook block 24.

The above descriptions are merely better specific implementations of the present disclosure, but the scope of protection of the present disclosure is not limited thereto. All equivalent replacements or changes made by any skilled in the art according to the technical solution of the present disclosure and the inventive concept thereof fall within the scope of protection of the present disclosure.

What is claimed is:

1. A plug type residual current operated protector, comprising:
a plug housing, wherein a circuit board is arranged inside the plug housing, a static electrical contact is arranged on the circuit board, one end of an elastic piece is fixedly mounted in the plug housing, and a free end of the elastic piece is provided with a moving electrical contact corresponding to a position of the static electrical contact;
a trip module, comprising a yoke, an armature, a lifter, and a hook block, wherein the yoke is arranged in a trip coil, the armature corresponds to a position of the yoke, one end of the armature is elastically connected to the plug housing through a first spring, the armature penetrates through the lifter, the hook block, and the trip coil, the lifter is in sliding connection to an interior of the plug housing, an extension arm is arranged on a side surface of the lifter, the extension arm extends below the elastic piece, the hook block is rotatably mounted in the lifter, an annular flange is arranged on the armature, the annular flange is in contact with a surface of the hook block, and a first hooking part is arranged at a top of the hook block; and
a reset button, which is elastically connected to the plug housing through a second spring, wherein one end of the second spring is in contact with a back surface of a pressing part of the reset button, an opposite end is in contact with the circuit board, a second hooking part configured to hook the first hooking part is provided at a bottom of the reset button, and contact surfaces of the second hooking part and the first hooking part are inclined surfaces.

2. The plug type residual current operated protector according to claim 1, wherein a chute with a shape matching the annular flange is provided on the hook block, and the annular flange is in sliding connection with an interior of the chute.

3. The plug type residual current operated protector according to claim 1, wherein contact surfaces of the extension arm and the elastic piece are cambered surfaces.

4. The plug type residual current operated protector according to claim 1, wherein a stop block corresponding a position of the first hooking part is arranged in the lifter.

5. The plug type residual current operated protector according to claim 1, wherein a surface of the plug housing is provided with a concave part, and the reset button is arranged on a bottom surface of the concave part.

6. The plug type residual current operated protector according to claim 1, wherein anti-slip groove bodies are provided on opposite side surfaces of the plug housing.
